(19) United States
(12) Patent Application Publication
(10) Pub. No.: US 2020/0337286 A1
(43) Pub. Date: Oct. 29, 2020

(54) FLY REEL AND MANUFACTURING METHOD THEREOF

(71) Applicants: Seong Hak KONG, Changwon-si (KR); Sung Jun KONG, Busan (KR); Seong Hun JEONG, Busan (KR); BAEKKYUNG CO., LTD., Changwon-si (KR)

(72) Inventors: Seong Hak KONG, Changwon-si (KR); Sung Jun KONG, Busan (KR); Seong Hun JEONG, Busan (KR)

(21) Appl. No.: 16/858,617

(22) Filed: Apr. 25, 2020

(30) Foreign Application Priority Data
Apr. 27, 2019 (KR) 10-2019-0049458

(51) Int. Cl. A01K 89/016; A01K 89/033; A01K 89/01

(52) U.S. Cl. CPC A01K 89/016; A01K 89/01931; A01K 89/011221; A01K 89/033

(57) ABSTRACT

A fly reel exclusively used for fly fishing is proposed. In the fly reel, a spool having a [symbol] -shape (bobbin shape) to be able to wind a fishing line thereon is composed of two left and right body sections, the body sections are formed and manufactured using a carbon sheet material, a metallic spool cover having a ring frame shape is integrally coupled to the outer surface of the body section disposed opposite a reel body of the left and right body sections, and a reel body disposed on a first side of the spool and supporting rotation of the spool in cooperation with a shaft member is also divided into a main body covering the first side of the spool and a body cover having a ring frame shape and coupled to the outer surface of the main body.

### CROSS REFERENCE TO RELATED APPLICATION

The present application claims priority to Korean Patent Application No. 10-2019-0049458, filed on Apr. 27, 2019, the entire contents of which is incorporated herein for all purposes by this reference.

### BACKGROUND OF THE INVENTION

### Field of the Invention

The present invention relates to a fly reel exclusively used for fly fishing, in which a spool having a [symbol] -shaped (bobbin shaped) cross-section to be able to wind a fishing line thereon is composed of two left and right body sections, the body sections are formed and manufactured using a carbon sheet material, a metallic spool cover having a ring frame shape is integrally coupled to the outer surface of the body section disposed opposite a reel body of the left and right body sections, a reel body disposed on a first side of the spool and supporting rotation of the spool in cooperation with a shaft member is also divided into a main body covering the first side of the spool and a main body cover having a ring frame shape and coupled to the outer surface of the main body, the main body is formed and manufactured using a carbon sheet material, and the main body cover is integrally coupled to the main body as a metallic frame, thereby having the appropriately combined advantages of carbon materials and metallic materials, and a manufacturing method thereof.

### Description of the Related Art

In general, fly fishing is a kind of fishing that hangs a so-called fly, which is made in the shapes of insets or worms that live at the water side by covering a fishhook with artificial materials or natural materials, on an exclusive line (fish line) and induces and hooks fish by flying the fly over the water surface using a casting rod and a fly reel. Fly reels that are exclusively used for fly fishing, as compared with fishing reels that are used for other kinds of fishing, are not provided with other complicated functions except for the fundamental function that rotates a spool only in the winding direction of a fishing line using a handle knob fastened to the spool.

A representative structure of such fly reels includes a spool having a [symbol] -shaped section to be able to wind a fishing line, a reel body having a reel bed and disposed like a side cover on a first side of the spool, a spool shaft disposed through the center of the spool from the reel body to support rotation of the spool, and a handle knob fastened to the edge of a second side of the spool. A drag knob is disposed on the outer surface of the reel body and a drag unit, which adjusts the drag force of the spool when the drag knob is rotated, is disposed on the spool shaft together with a one-way bearing.

In order to manufacture the reel body and the spool that are main components of the fly reels, machining that manufactures a reel body and a spool in requested shapes using a machine tool such as MCT or CNC using aluminum materials, die casting that casts a reel body and a spool in requested shapes using a mold, and injection molding that forms a reel body and a spool in requested shapes using a plastic injection mold are representatively used.

However, when the entire reel body and spool of a fly reel are manufactured using an aluminum material, there is a problem that it is very difficult to machine a reel body and a spool in accurate shapes with accurate dimensions using MCT or CNC, and it is also difficult to manufacture parts in large quantities because the all processes depend on only machining work, so the productivity of the fly reel decreases and the manufacturing cost thereof increases. Further, there was a problem that the aluminum material itself is easily corroded by salt water or water, so the durability and the lifespan of the fly reel are considerably deteriorated.

In order to make up for these problems, alumite is additionally applied to the surfaces of a reel body and a spool (the surface of aluminum is coated with an aluminum oxide film to increase anticorrosion and abrasion resistance), but whitening quickly occurs when they are exposed to salt water in spite of the applying and the aesthetic external appearance is not good after the applying. Further, since the aluminum fly reel itself is relatively heavy, there was a problem that users feel considerably tired due to the characteristic of fly fishing where a fisherman continuously casts a fly to desired distances by casting a fishing line.

On the other hand, when a fly reel, a reel body, and a spool are manufactured by die casting or plastic injection molding, there is an advantage that the manufacturing processes are relatively simple and it contributes to reducing the weight of the fly reel, but the structural strength of the parts is low because blowholes are easily produced in the reel body of the body of the spool in the process of die casting. Further, when a reel body and a spool are manufactured by plastic injection molding, they are easily deformed or broken by external shock, etc.

Accordingly, in these cases, low-cost products for beginners are usually produced rather than expensive products for skilled people.

### SUMMARY OF THE INVENTION

The present invention has been made in an effort to solve the problems in the related art, and an objective of the present invention is to provide a fly reel exclusively used for fly fishing, in which a spool having a [symbol] -shape to be able to wind a fishing line thereon is composed of two left and right body sections, the body sections are formed and manufactured using a carbon sheet, a metallic spool cover having a ring frame shape is integrally coupled to the outer surface of the body section disposed opposite a reel body of the left and right body sections, a reel body disposed on a first side of the spool and supporting rotation of the spool in cooperation with a shaft member is also divided into a main body covering the first side of the spool and a main body cover having a ring frame shape and coupled to the outer surface of the main body, the main body is formed and manufactured using a carbon sheet, and the main body cover is integrally coupled to the main body as a metallic frame, thereby having the appropriately combined advantages of carbon materials and metallic materials, having light weight and high strength, and having considerably increased durability and lifespan due to little corrosion by salt water or water, and a manufacturing method thereof. Further, the technological subject of the present invention is to provide a fly reel and a manufacturing method thereof that can provide a high value-added product with a more aesthetic and elegant external appearance by applying a pattern on a carbon sheet, and considerably improve productivity by reducing the manufacturing processes by MCT or CNC and making the entire manufacturing process easier and simpler, thereby being able to provide a high-quality product that skilled people prefer at a reasonable price.

In order to achieve the objectives, a fly reel according to the present invention includes a spool having a [symbol] -shaped (bobbin shaped) cross-section to be able to wind a fishing line, a reel body having a reel bed and disposed on a first side of the spool like a side cover, a shaft member disposed horizontally through a center of the spool from the reel body and supporting rotation of the spool, and a handle knob fastened to an edge of a second side of the spool, in which the spool is formed by fitting and fastening two left and right body sections that have the [symbol] -shaped cross-section to each other; the body sections are each formed and manufactured using a carbon sheet material and a spool cover having a ring frame shape is fastened to an outer surface of a right body section disposed opposite the reel body of the left and right body sections of the spool; the spool cover is a metallic frame having a main frame providing an external shape of the ring frame and an assembly frame stepped and protruding from an inner surface of the main frame and fitted to an edge of the right body section; at least two fastening portions protrude from an inner surface of the assembly frame; the right body section and the spool cover are coupled by at least two assembly screws fastened through an edge of the right body section and the fastening portions of the assembly frame; and the handle knob is fastened to the spool cover by one of the at least two assembly screws.

The reel body has a main body covering the first side of the spool and a main body cover having a ring frame shape fastened to an outer surface of the main body, the main body is formed and manufactured using a carbon sheet material, the main body cover is a metallic frame, and the reel bed is fastened to the main body cover; and the main body cover has a main frame providing am external shape of the ring frame and an assembly frame protruding from an inner surface of the main frame and fitted to an edge of the main body, at least two fastening portions protrude from an inner surface of the assembly frame, and the main body and the main body cover are fastened to each other by assembly screws tightened through an edge of the main body and fastening portions of the assembly frame.

A method of manufacturing the fly reel according to the present invention sequentially performs a body section-forming process that primarily forms external shapes of the two left and right body sections composing the spool using carbon sheets and a mold and a body section-machining process that machines the primarily formed body sections into the final requested external shapes, and further performing a spool cover-manufacturing process that manufactures the spool cover in a ring frame shape that is fastened to edges of the body sections using a metallic material such as aluminum, in which after the body section-machining process and the spool cover-manufacturing process, a spool-assembling process that manufactures the spool by fastening the spool cover and the hand knob to an outer surface of the right body section disposed opposite the reel body of the two body sections and then fitting and fastening the body sections to each other and a commercializing process that fastens the spool manufactured through the spool-assembling process to the reel body together with the shaft member are performed, in which the reel body is formed by fastening a main body cover having a ring frame shape to an outer surface of the main body covering the first side of the spool; the main body is manufactured sequentially through a main body-forming process that primarily forms an external shape of the main body using a carbon sheet and mold and a main body-machining process that machines the primarily formed main body into a requested final external shape; and the main body cover is manufactured as a metallic frame.

In the method, the body section-forming process and the main body-forming process are performed sequentially through a carbon sheet-cutting process that cuts carbon sheets having a thickness of 0.1˜0.2 mm into a predetermined size, a carbon sheet-bonding process that stacks and bonds two to four cut carbon sheets, a bonded sheet-cutting process that cuts the bonded carbon sheets to fit to forming surfaces of an upper mold and a lower mold, and a primary forming process that puts the cut bonded sheets onto the forming surface of the lower mold, brings the upper mold and the lower mold in contact with each other, and then heats the upper and lower molds at temperature of 120˜140 degrees for 60˜80 minutes to primarily form an external shape of the body sections or the main body; the body section-machining process and the main body-machining process are performed sequentially through a machining process that finally machines the body sections or the main body into a requested shape using a machine tool such as MCT or CNC, a barreling process that removes burrs on the machined body sections or main body, a polishing process that machines an outer surface of the barreled body sections or main body with an abrasive stone, and an applying process that performs matt coating or glossy coating on a surface of the body sections or the main body; and after the primary forming process is finished, a pattern sheet-setting process that puts 3K carbon as a pattern sheet cut in the same shape as the bonded sheet onto an upper surface and a lower surface of the primarily formed body sections or main body and then presses the upper mold and the lower mold and a secondary forming process that applies a specific pattern on a surface of the body sections or the main body by heating the upper mold with the pattern sheet set thereon at temperature of 110˜130 degrees for 40˜50 minutes are further performed.

According to the present invention, the main body portions of the spool divided into two left and right body sections and the reel body are formed and manufactured using a carbon material that is about ½ to ⅓ lighter and about 5 to 10 times stronger than metallic materials such as aluminum, and a metallic ring frame such as aluminum is fastened only to the outer surface of the right body section disposed opposite the reel body and the outer surface of the main body to be able to prevent elastic twist of the body portions formed and manufactured by a carbon material, thereby appropriately combining only the advantages of carbon materials and metallic materials. Therefore, it is possible to provide a fly reel that is light and has high strength.

Further, since the most portions of the bodies of the spool and the main body are made of a carbon material, corrosion or whitening due to salt water or water is generated, thereby being able to considerably increase the durability and lifespan of a fly reel. Further, it is possible to provide a high value-added fly reel with more elegant external appearance by attaching 3K carbon having an aesthetic pattern to the outer surfaces of the spool and the reel body. Further, the machining processes by MCT or CNC are reduced and the entire manufacturing process is made easier and simpler, thereby significantly improving productivity and providing a reasonable priced high-quality fly reel that skilled people prefer.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is an exploded perspective view of a fly reel according to the present invention;

FIG. 2 is a front cross-sectional view showing the assembly state of a reel body shown in FIG. 1;

FIG. 3 is a front cross-sectional view showing a primary assembly state of a spool shown in FIG. 1;

FIG. 4 is a front cross-sectional view showing the final assembly state of the spool shown in FIG. 3;

FIG. 5 is a front cross-sectional view showing the assembled state of FIG. 1;

FIG. 6 is a flowchart showing a method of manufacturing a fly reel according to the present invention;

FIG. 7 is a flowchart showing a process of forming body sections and a process of forming a main body;

FIG. 8 is a flowchart showing a process of machining the body sections and a process of machining the main body;

FIG. 9 is a side cross-sectional view showing the state after body sections are formed by upper and lower molds; and

FIG. 10 is a side cross-sectional view showing the state after a main body is formed by upper and lower molds.

### DETAILED DESCRIPTION OF THE INVENTION

Hereafter, the present invention for achieving the objects described above is described in detail with reference to the accompanying drawings.

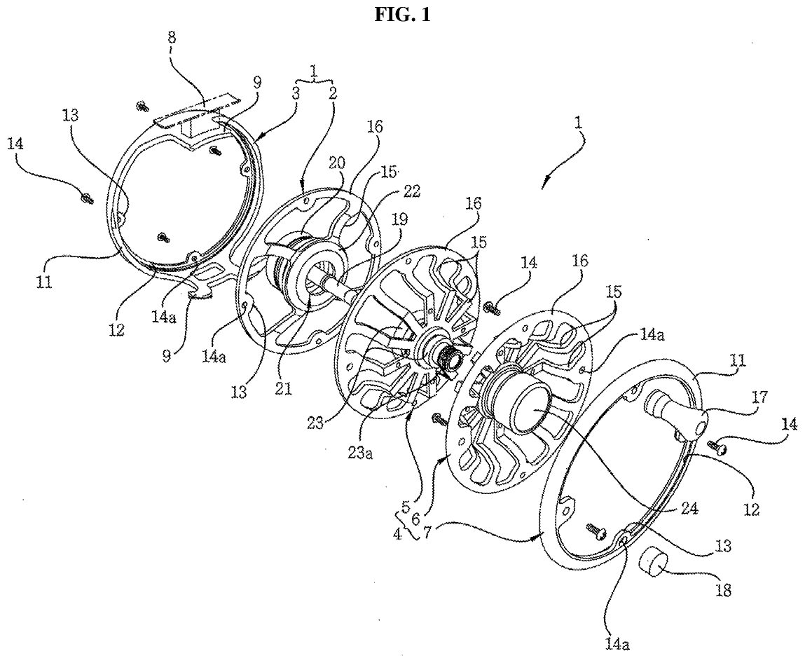

A fly reel 10 according to the present invention, as shown in FIGS. 1 to 5, includes, as fundamental components, a spool 4 having a [symbol] -shaped (bobbin shaped) cross-section to be able to wind a fishing line, a reel body 1 having a reel bed 8 and disposed on a first side (the left side in the figures) of the spool 4 like a side cover, a shaft member disposed horizontally through the center of the spool 4 from the reel body 1 and supporting rotation of the spool 4, and a handle knob 17 fastened to the edge of a second side (the right side in the figures) of the spool 4.

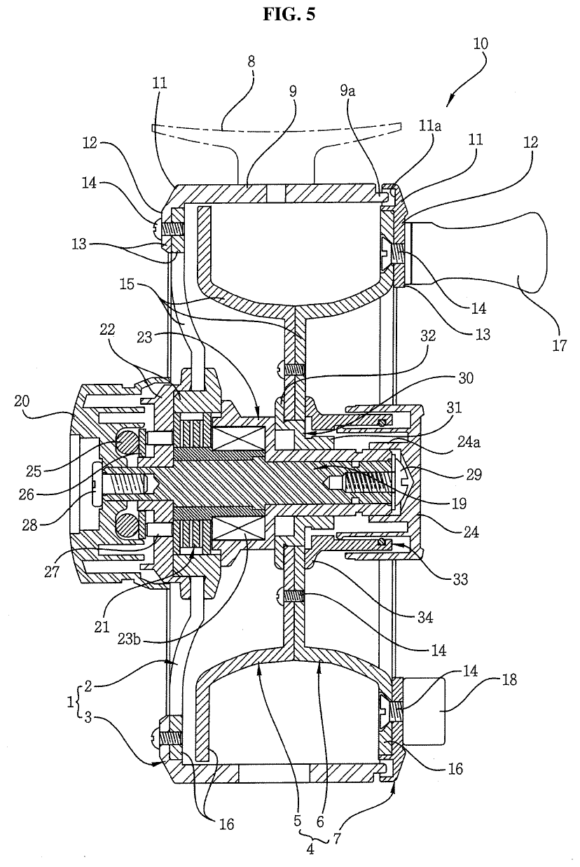

The shaft member, as known in the art, includes a spool shaft 19 disposed horizontally through the center of the spool 4, a drag knob 20 fastened to a first end of the spool shaft 19 and positioned outside the reel body 1, and a fastening knob 24 fastened to a second end of the spool shaft 19 pushing the first side (the left side in the figures) of the spool 5 close to the inner surface of the reel body 1. As more clearly shown in FIG. 5, a mounting bolt 28 and a retainer bolt 29 that prevent separation of the drag knob 20 and a spool hub 23 are fastened to both ends of the spool shaft 19, respectively.

The spool hub 23 is a part that rotates with the spool 4 in a fishing line-winding direction on the spool shaft 19 with a one-way bearing 23b therebetween. A fastening portion 23a for assembling the fastening knob 24 is formed at the front end of the spool hub 23. A nut cap 24a covering the head of the retainer bolt 29 and coupled to the fastening portion 23a of the spool hub 23 is disposed at the center inside the fastening knob 24. The drag knob 20, as known in the art, performs a function of adjusting the attraction force (drag force) between the drag unit 21 and the spool hub 23.

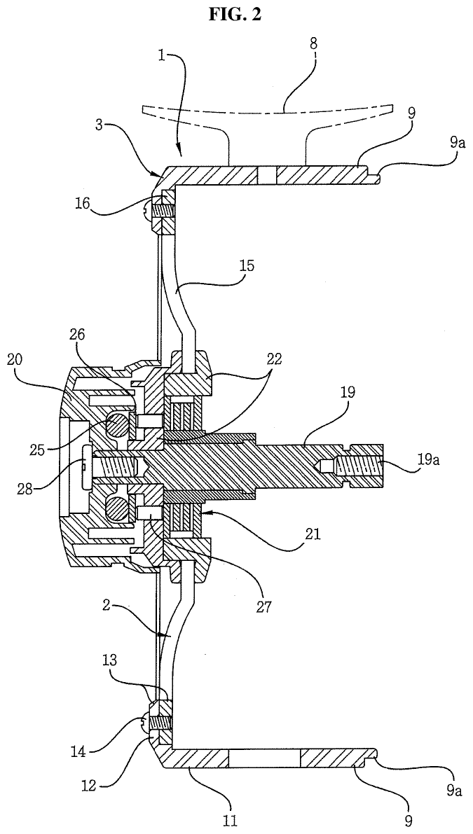

The drag unit 20 is fitted on the spool shaft 19 inside a drag cover 22 fastened to the reel body 1 through usually two to four metal washers and thin elastic pads disposed between the metal washers. As more clearly shown in FIGS. 2 and 5, a pressing ring 25, a pressing plate 26, and a pressing pin 27 are sequentially disposed inside the drag knob 20 to adjust the drag force of the spool 4 by selectively bringing the drag unit 21 in contact with a first end (the left end in the figure) of the spool hub 23.

The pressing ring 25 and the pressing plate 26 are fitted on the spool shaft 19 extending through the reel body 1, between the drag knob 20 and the reel body 1. At least two pressing pins 27 are provided and disposed through the drag cover 22 fastened to the reel body 1 to bring the front end thereof (the right end in the figures) in contact with the drag unit 21. The drag cover 22 and the spool hub 23 should be spaced apart from each other with a predetermined gap therebetween for rotation of the spool 4, so a step that limits the setting position of the spool hub 23 is formed on the spool shaft 19.

Accordingly, when the drag knob 20 is rotated to be tightened, the drag knob 20 moves inward (to the right in the figures) on the spool shaft 19 and presses the pressing ring 25, whereby the pressing ring 25, the pressing plate 26, and the pressing pin 27 push the drag unit 21 toward the spool hub 23. Accordingly, the attraction force between the drag unit 21 and the spool hub 23 increases, whereby the drag force can be increased. When the drag knob 20 is rotated to be loosened, the attraction force between the drag unit 21 and the spool hub 23 decreases in the opposite way to the process described above, so the drag force can be decreased.

The shaft member described above is only a representative example that can be applied to the present invention and it should be noted that shaft members and drag members that have various structures such as those stated in the above prior art documents can be applied to the fly reel 10 of the present invention. Further, it should be noted that, if necessary, a well-known clicker that generates a clicking sound when the drag knob 20 is rotated may be additionally disposed between the drag knob 20 and the reel body 1.

As components corresponding to a first main part of the present invention, as shown in FIGS. 1, 3, and 4, the spool 4 having a [symbol] -shaped cross-section is formed by manufacturing two separate left and right body sections 5 and 6 and the fitting and coupling the body sections 5 and 6 to each other. The body sections 5 and 6 are formed and manufactured in requested shapes using carbon sheets. A spool cover 7 having a ring frame shape is coupled to the outer surface of the body section 6 disposed opposite the reel body (at the right side in the figures) of the left and right body sections 5 and 6, and the spool cover 7 is a frame made of a metallic material such as aluminum.

Referring to FIG. 1, the body sections 5 and 6 each have a structure having a body 15 with several (a total of twelve in the figure) frames radially formed from the center through which the spool hub 23 is assembled, and a circular edge 16 connecting the ends of the frames, but this is only a representative example that can be applied to the present invention and it should be noted that the body sections 5 and 6 may have any shapes as long as they it is possible to provide the spool 4 having a [symbol] -shaped cross-section to be able to wind and keep a fishing line with a predetermined length.

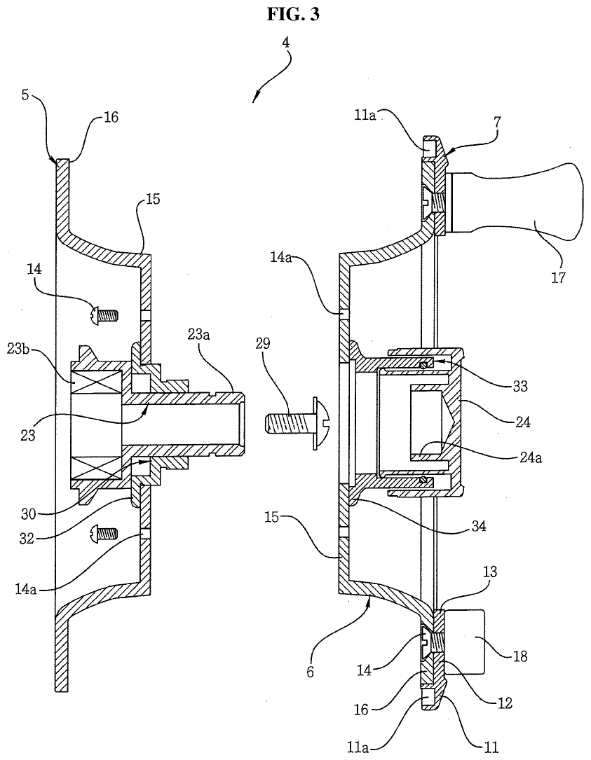

Further, as shown in FIGS. 1 and 3, the spool cover 7 has a main frame 11 providing the external shape of the ring frame and an assembly frame 12 stepped and protruding from the inner surface of the main frame 11 and fitted to the edge 16 of the body section 6. At least two (a total of four) fastening portions 13 protrude from the inner surface of the assembly frame 12, and the body section 6 and the spool cover 7 are coupled by assembly screws 14 fastened through the edge 16 of the body section 6 and the fastening portions 13 of the assembly frame 12.

When the spool cover 7 is coupled to the body section 6, it is possible to more easily assemble the spool cover 7 and the body section 6 and it is possible to secure sufficient assembly strength between the spool cover 7 and the body section 6 by primarily bonding the assembly frame 12 and the edge 16 using an adhesive and then fastening them using the assembly screws 14. Other than this assembly structure, it is possible to apply various types of assembly structures that are fitted by prominences and recessions to the inner surface of the spool cover 7 and the outer surface of the body section 6, and if necessary, it may be possible to selectively apply only one of the bonding type and the fastening type.

The handle knob 17 for the spool 4 may be coupled to the spool cover 7 using one assembly screw 14. A well-known balance weight 18 may be fastened to the outer surface of the spool cover 7 facing the handle knob 17 using assembly screws 14 so that rotation of the spool 4 using the handle knob 7 can be stably performed with the balance maintained. Even though the spool 4 is manufactured by coupling the left and right body sections 5 and 6, it may be possible to primarily bond the bodies 15 of the body sections 5 and 6 fitted to each other and then fasten assembly screws 14 into fastening holes 14a formed through the bodies 15 to correspond to each other.

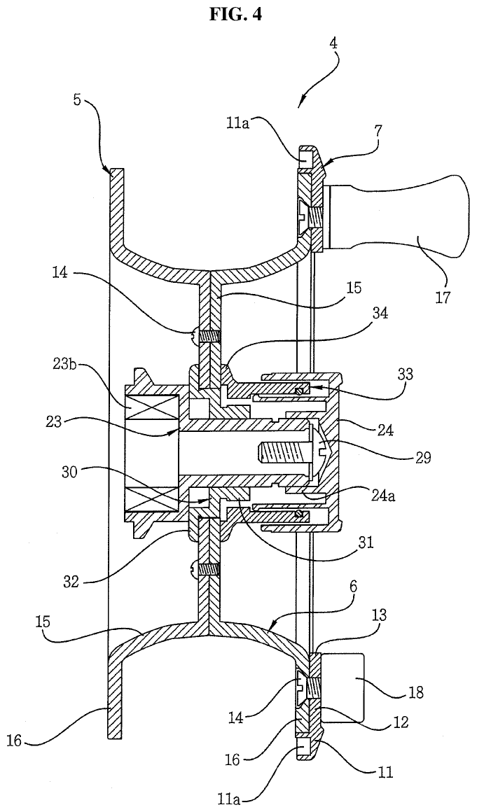

To this end, as shown in FIGS. 3 and 4, a spool holder 30 is disposed on the outer surface of the spool hub 23 through the centers of the bodies 15 of the body sections 5 and 6. A holder cap 33 for pressing the bodies 15 of the body sections 5 and 6 to each other is disposed on the inner surface of the fastening knob 24. The spool holder 30 has a supporting flange 32 protruding from the edge of a fitting portion 31 fitted on the spool hub 23 and rotating with the spool hub 23. The holder cap 33 has a pressing flange 34 protruding from an end of a cylindrical body disposed on the inner surface of the fastening knob 24. Accordingly, when the fastening knob 24 is fitted on the fastening portion 23a at the front end of the spool hub 23, the bodies 15 of the body sections 5 and 6 can be firmly in close contact with each other by the supporting flange 32 of the spool holder 30 and the pressing flange 34 of the holder cap 33, whereby it is possible to more easily and accurately primarily bond the bodies 15 of the body sections 5 and 6 and then finally fasten the bodies 15 of the body sections 5 and 6 using the assembly screws 14. Further, if necessary, it may be possible to selectively apply only one of the bonding type and the fastening type.

The reel body 1 that is a second main part of the present invention, as show in FIGS. 1 and 2, includes a main body 2 covering a first side of the spool 4 and a main body cover 3 having a ring frame shape and fastened to the outer surface of the main body 2. The main body 2 is formed and manufactured using a carbon sheet, the main body cover 3 is a frame made of a metallic material such as aluminum, and the reel bed 8 is fastened to the main body cover 3. Further, the reel bed 8 is fastened to the top side arm 9 of a plurality of side arms 9 (two in the figures) horizontally protruding from the main body cover 3 to protect the spool 4.

Further, the main body cover 3 has a main frame 11 providing the external shape of the ring frame and an assembly frame 12 stepped and protruding from the inner surface of the main frame 11 and fitted to the edge of the main body 2. At least two fastening portions 13 (a total of four in the figures) protrudes from the inner surface of the assembly frame 12, and the main body 2 and the main body cover 3 are fastened to each other by assembly screws 14 tightened through the edge of the main body 2 and the fastening portions 12 of the assembly frame 12.

Referring to FIG. 1, the main body 2 has a body 15 having several frames (a total of four in the figure) radially formed from the center through which the drag cover 22 is assembled, and a circular edge 16 connecting the ends of the frames, but it is also only one representative example that can be applied to the present invention, so it should be noted that any external shape can be applied as long as it can cover the first side (the left side in the figure) of the spool 4 like a side plate. The fastening portions 13 corresponding to the main body cover 3 protrude from the inner surface of the edge 16 of the main body 2.

The reason of defining the spool 4 as the first main part and the reel body 2 as the second main part in the present invention, as described above, is because the spool 4 weighs more than the reel body 1 and it takes more time for machining to manufacture the spool 4 than to manufacture the reel body 4 when the spool 4 and the reel body 1 are manufactured using a metallic material such as aluminum, so it is advantageous in terms of reducing the weight and the manufacturing cost of the fly reel 10 to manufacture the spool 1 first if one of the two parts has to be manufactured first using a carbon material.

However, it should be noted that if necessary, the spool 4 is made of a metallic material such as aluminum, only the reel body 1 may be manufactured to have the main body 2 made of a carbon material and the main body cover 3 made of a metal material, and the spool cover 7 can be applied to both of the left and right body sections 5 and 6 of the spool 4. In this case, it is required to prevent the body section 5 including the spool cover 7 and disposed inside the reel body 1 from coming in contact with the inner surfaces of the side arms 9 of the reel body 1 by making the dimensions of the spool cover 7 small or making the diameter of the body section 5 itself small.

Further, as more clearly shown in FIG. 5, a protrusion 9a is stepped and protrudes from the end of each of the side arms 9 and a guide groove 11a in which the protrusions 9a of the side arms 9 are inserted is formed at the main frame 11, thereby providing a structure that prevents the fishing line wound on the spool 4 from easily coming out through between the side arms 9 and the spool cover 7. The drag cover 22 also has a structure formed by fastening left and right separate bodies to each other using a bonding type or a fastening type to be able to firmly clamp the main body 2 of the reel body 1.

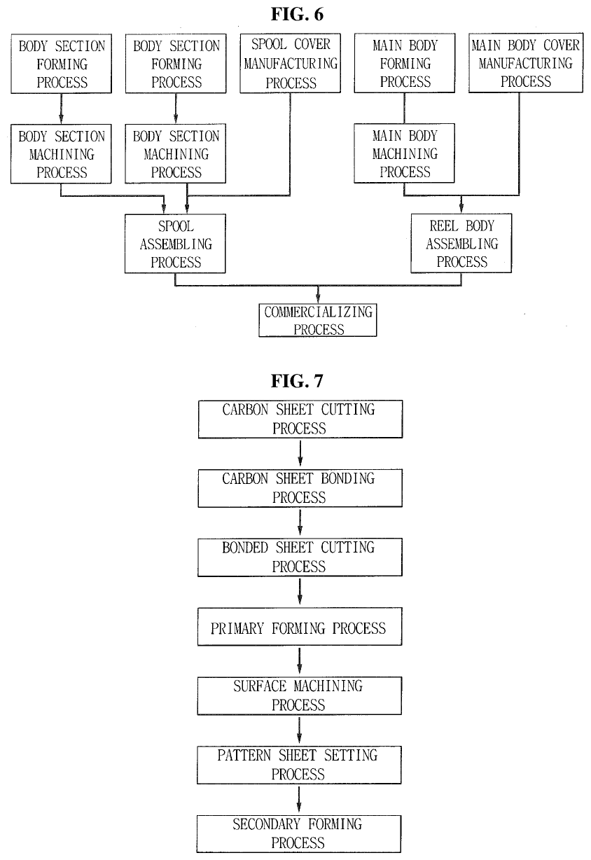

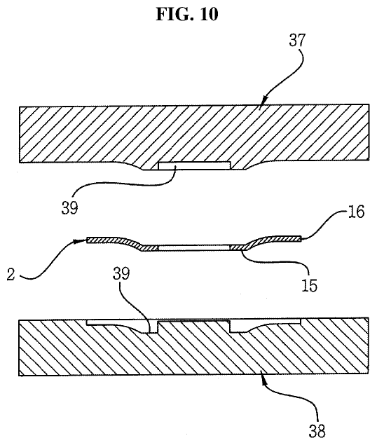

Hereafter, a manufacturing method of the present invention for manufacturing the fly reel 10 having the configuration described above is described in detail with reference to FIGS. 6 to 10.

A method of manufacturing a fly reel according to the present invention sequentially performs a body section-forming process that primarily forms the external shapes of the two left and right body sections 5 and 6 composing the spool 4 using carbon sheets 35 and a mold and a body section-machining process that machines the primarily formed body sections 5 and 6 into the finally requested external shapes. The method further performs a spool cover-manufacturing process that manufactures the spool cover 7 in a ring frame shape that is fastened to the edges of the body sections 5 and 6 using a metallic material such as aluminum.

By performing the body section-machining process and the spool cover-manufacturing process, as described above, after the two body sections 5 and 6 that are carbon parts and the spool cover 7 that is a metallic frame are manufactured, a spool-assembling process that manufactures the spool by fastening the spool cover 7 and the hand knob 17 to the outer surface of the body section 6 disposed opposite the reel body 1 of the two body sections 5 and 6 and then fitting and fastening the body sections 5 and 6 to each other, and a commercializing process that fastens the spool 4 manufactured through the spool-assembling process to the reel body 1 together with a shaft member are performed, thereby finishing machining the fly reel 10.

The reel body 1 is also manufactured by sequentially performing a main body-forming process that primarily forms the external shape of the main body 2 using a carbon sheet and a mold and a main body-machining process that machines the primarily formed main body 2 into a finally requested external shape, in which a main body cover-manufacturing process that manufactures the main body cover 3 having a ring frame shape that is fastened to the edge of the main body using a metallic material such as aluminum is further performed. Accordingly, the main body 2 and the main body cover 3 are manufactured and then a reel body-assembling process that fastens the main body 2 and the main body cover 3 is performed, whereby the reel body 1 is manufactured.

As described above, the spool-assembling process that uses the two body sections 5 and 6 and the spool cover 7 and the reel body-assembling process that uses the main body 2 and the main body cover 3 has been briefly stated above with reference to FIGS. 2 to 4. Further, the spool cover-manufacturing process and the main body cover-manufacturing process are well-known processes that machine metallic frames such as aluminum into requested shapes using machine tools such as MCT or CNC and the commercializing process that install the spool 4 on a shaft member together with the reel body 1 can be sufficiently understood even only from those shown in FIGS. 1 to 5, so these processes are not described in detail.

In detail, the body section-forming process and the main body-forming process are performed, as shown in FIGS. and 10, sequentially through a carbon sheet-cutting process that cuts carbon sheets 35 having a thickness of 0.1˜0.2 mm into a predetermined size, a carbon sheet-bonding process that stacks and bonds two to four cut carbon sheets 35, a bonded sheet-cutting process that cuts the bonded carbon sheets 35 to fit to the forming surfaces 39 of an upper mold 37 and a lower mold 38, and a primary forming process that puts the cut bonded sheets onto the forming surface 39 of the lower mold 38, brings the upper mold 37 and the lower mold 38 in contact with each other, and then heats the upper and lower molds 37 and 38 at temperature of 120˜140 degrees for 60˜80 minutes to primarily form the external shape of the body sections 5 and 6 or the main body 2.

In the carbon sheet-cutting process and the bonded sheet-cutting process, several carbon sheets 35 may be simultaneously cut into predetermined size and shape using a 24 ton-carbon press set. In the carbon sheet-bonding process, minimally two to maximally four carbon sheets 35 are used to be able to increase the strength and reduce the weight and manufacturing cost of the spool 4 and the reel body 1, in which the carbon sheets 35 are stacked and bonded with patterns on the carbon sheets 35 overlapping each other. The temperature and time that are applied in the primary forming process are optimal ranges in which both of the strength and the dimension precision of the body sections 5 and 6 or the main body 2 can be secured.

Further, after the primary forming process is finished, the method may additionally perform a pattern sheet-setting process that puts 3K carbon as a pattern sheet 36 cut in the same shape as the bonded sheet onto the upper surface and the lower surface of the primarily formed body sections 5 and 6 or main body 2 and then presses the upper mold 37 and the lower mold 38, and a secondary forming process that applies a specific pattern on the surface of the body sections 5 and 6 or the main body 2 by heating the upper mold with the pattern sheet set thereon at temperature of 110˜130 degrees for 40˜50 minutes.

Fine scratches suitable for bonding the pattern sheet 36 are formed on the upper surface and the lower surface of the primarily formed body sections 5 and 6 or the main body 2 through polishing with a sandpaper between the primary forming process and the secondary forming process. The secondary forming process is a process that attaches only one pattern sheet 36 to each of the upper and lower surfaces of the primarily formed body sections 5 and 6 or the main body 2, so the heating temperature is lowered by about 10 degrees and the heating time is decreased by about 30 minutes in comparison to the primary forming process.

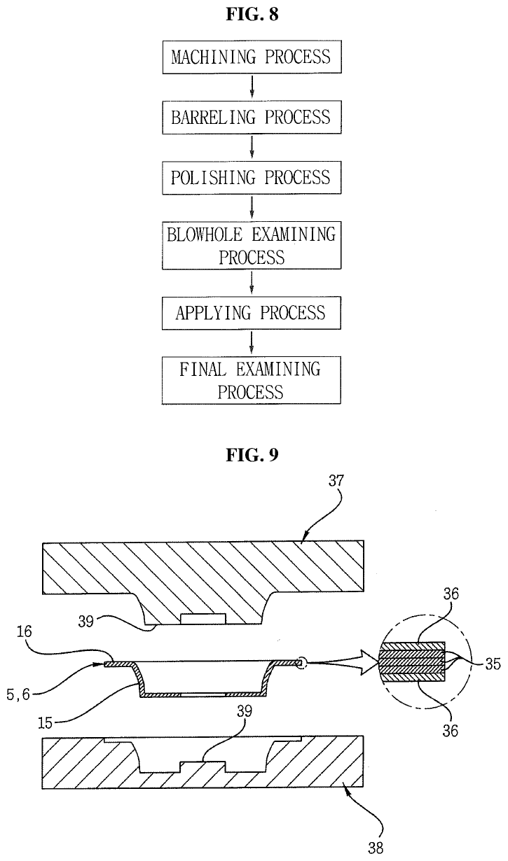

The body section-machining process and the main body-machining process that are performed after the body section-forming process and the main body-forming process are performed, in detail, as shown in FIG. 8, sequentially through a machining process that finally machines the body sections 5 and 6 or the main body 2 into a requested shape using a machine tool such as MCT or CNC, a barreling process that removes burrs on the machined body sections 5 and 6 or main body 2, a polishing process that machines the outer surface of the barreled body sections 5 and 6 or main body 2 with an abrasive stone, and an applying process that performs matt coating or glossy coating on the surface of the body sections 5 and 6 or the main body 2.

The machining process, barreling process, and polishing process are general processes that are widely applied not only in manufacturing of the fly reel 10, but also in other several fields, and the abrasive stone that is used in the polishing process may be any abrasive stone as long as it has granularity of about #800˜#1000. A blowhole-examining process that determines whether there are blowholes by passing the body sections 5 and 6 or the main body 2 through between a semiconductor light projector and a high-sensitivity light receiver may be performed between the barreling process and the polishing process. The applying process may use a well-known clear or glass film coating method. After the applying process is finished, the method may enter the commercializing process after finally examining whether there are scratches on the surface of the body sections 5 and 6 or the main body 2. According to the present invention having the configuration described above, the main body portions of the spool 4 divided into two left and right body sections 5 and 6 and the reel body 1 are formed and manufactured using a carbon material that is about ½ to ⅓ lighter and about 5 to 10 times stronger than metallic materials such as aluminum, and a metallic ring frame such as aluminum is fastened only to the outer surface of the body section 6 disposed opposite the reel body 1 and the outer surface of the main body 2 to be able to prevent elastic twist of the body portions formed and manufactured by a carbon material, thereby appropriately combining only the advantages of carbon materials and metallic materials. Therefore, it is possible to provide a fly reel 10 that is light and has high strength.

Further, since the most portions of the bodies of the spool 4 and the main body 1 are made of a carbon material, corrosion or whitening due to salt water or water is little generated, thereby being able to considerably increase the durability and lifespan of a fly reel 10. Further, it is possible to provide a high value-added fly reel 10 with more elegant external appearance by attaching 3K carbon having an aesthetic pattern to the outer surfaces of the spool 4 and the reel body 1. Further, the machining processes by MCT or CNC is reduced and the entire manufacturing process is made easier and simpler, thereby significantly improving productivity and providing a high-quality fly reel 10 that skilled people prefer at a reasonable price.

What is claimed is:

1. A fly reel comprising a spool having a [symbol] -shaped (bobbin shaped) cross-section to be able to wind a fishing line, a reel body having a reel bed and disposed on a first side of the spool like a side cover, a shaft member disposed horizontally through a center of the spool from the reel body and supporting rotation of the spool, and a handle knob fastened to an edge of a second side of the spool, in which the spool is formed by fitting and fastening two left and right body sections that have the [symbol] -shaped cross-section to each other,
wherein the body sections are each formed and manufactured using a carbon sheet material and a spool cover having a ring frame shape is fastened to an outer surface of a right body section disposed opposite the reel body of the left and right body sections of the spool, and
the spool cover is a metallic frame having a main frame providing an external shape of the ring frame and an assembly frame stepped and protruding from an inner surface of the main frame and fitted to an edge of the right body section.

2. The fly reel of claim 1, wherein at least two fastening portions protrude from an inner surface of the assembly frame, the right body section and the spool cover are coupled by at least two assembly screws fastened through an edge of the right body section and the fastening portions of the assembly frame, and the handle knob is fastened to the spool cover by one of the at least two assembly screws.

3. The fly reel of claim 1, wherein the reel body has a main body covering the first side of the spool and a main body cover having a ring frame shape fastened to an outer surface of the main body; and
the main body is formed and manufactured using a carbon sheet material, the main body cover is a metallic frame, and the reel bed is fastened to the main body cover.

4. The fly reel of claim 3, wherein the main body cover has a main frame providing am external shape of the ring frame and an assembly frame protruding from an inner surface of the main frame and fitted to an edge of the main body;
at least two fastening portions protrude from an inner surface of the assembly frame, and the main body and the main body cover are fastened to each other by assembly screws tightened through an edge of the main body and fastening portions of the assembly frame.

5. A method of manufacturing the fly reel of claim 1, sequentially performing a body section-forming process that primarily forms external shapes of the two left and right body sections composing the spool using carbon sheets and a mold and a body section-machining process that machines the primarily formed body sections into the final requested external shapes, and further performing a spool cover-manufacturing process that manufactures the spool cover in a ring frame shape that is fastened to edges of the body sections using a metallic material such as aluminum,
wherein after the body section-machining process and the spool cover-manufacturing process, a spool-assembling process that manufactures the spool by fastening the spool cover and the hand knob to an outer surface of the right body section disposed opposite the reel body of the two body sections and then fitting and fastening the body sections to each other, and a commercializing process that fastens the spool manufactured through the spool-assembling process to the reel body together with the shaft member are performed.

6. The method of claim 5, wherein the reel body is formed by fastening a main body cover having a ring frame shape to an outer surface of the main body covering the first side of the spool, and
the main body is manufactured sequentially through a main body-forming process that primarily forms an external shape of the main body using a carbon sheet and mold and a main body-machining process that machines the primarily formed main body into a requested final external shape, and the main body cover is manufactured as a metallic frame.

7. The method of claim 6, wherein the body section-forming process and the main body-forming process are performed sequentially through a carbon sheet-cutting process that cuts carbon sheets having a thickness of 0.1˜0.2 mm into a predetermined size, a carbon sheet-bonding process that stacks and bonds two to four cut carbon sheets, a bonded sheet-cutting process that cuts the bonded carbon sheets to fit to forming surfaces of an upper mold and a lower mold, and a primary forming process that puts the cut bonded sheets onto the forming surface of the lower mold, brings the upper mold and the lower mold in contact with each other, and then heats the upper and lower molds at temperature of 120˜140 degrees for 60˜80 minutes to primarily form an external shape of the body sections or the main body; and
the body section-machining process and the main body-machining process are performed sequentially through a machining process that finally machines the body sections or the main body into a requested shape using a machine tool such as MCT or CNC, a barreling process that removes burrs on the machined body sections or main body, a polishing process that machines an outer surface of the barreled body sections or main body with an abrasive stone, and an applying process that performs matt coating or glossy coating on a surface of the body sections or the main body.

8. The method of claim 7, wherein after the primary forming process is finished, a pattern sheet-setting process that puts 3K carbon as a pattern sheet cut in the same shape as the bonded sheet onto an upper surface and a lower surface of the primarily formed body sections or main body and then presses the upper mold and the lower mold, and a secondary forming process that applies a specific pattern on a surface of the body sections or the main body by heating the upper mold with the pattern sheet set thereon at temperature of 110˜130 degrees for 40˜50 minutes are further performed.
